(19) United States
(12) Patent Application Publication
(10) Pub. No.: US 2026/0237895 A1
(43) Pub. Date: Aug. 13, 2026

(54) ANTENNA FILTER RF FRONTEND MODULE

(71) Applicant: Telefonaktiebolaget LM Ericsson (publ), Stockholm (SE)

(72) Inventors: Weigang ZENG, Nepean (CA); Marthinus DA SILVEIRA, Ottawa (CA); Neil MCGOWAN, Stittsville (CA)

(73) Assignee: Telefonaktiebolaget LM Ericsson (publ), Stockholm (SE)

(21) Appl. No.: 19/153,507

(22) PCT Filed: Feb. 6, 2023
(86) PCT No.: PCT/IB2023/051058

§ 371 Date: Aug. 4, 2025

(51) Int. Cl. H01Q 1/50; H01Q 1/02; H01Q 1/24; H01Q 21/08

(52) U.S. Cl. CPC H01Q 1/50; H01Q 1/02; H01Q 1/24; H01Q 21/08

(57) ABSTRACT

Embodiments of an antenna filter radio frequency (RF) frontend module (AFRFM) for use in an Antenna Array System (AAS). The AFRFM includes an antenna subarray including a plurality of antenna elements configured to transmit/receive RF signals. At least one antenna radiation wall is configured to limit coupling between the antenna elements and provide ground plane continuity between the antenna subarray and a second antenna subarray associated with an adjacent antenna frontend module.

### TECHNICAL FIELD

The present disclosure relates to Antenna Array Systems (AASs) and in particular to Antenna Filter RF Frontend Module.

### BACKGROUND

To save weight and improve performance, integrated filter and antenna units are required in 4G, 5G and 6G Antenna Array Systems (AASs). In Frequency Division Duplex (FDD) AASs, the Passive Inter-Modulation (PIM) performance of the antennas and filters must meet very stringent requirements due to the simultaneous transmit and receive requirements for the system. A method is also required to tune the filter response.

Existing AAS products are configured as a filter module connected to an antenna module via a cable and connectors. The filter module typically includes electronic circuitry providing baseband processing, up/down-conversion, power amplifier (PA) and noise filtering functions. The antenna module typically contains an array of antenna elements (also known as radiators) as well as a signal power divider and feedlines for conducting signals from the filter module to each radiator of the array.

This arrangement is advantageous in that the grouping of baseband processing, up/down-conversion, power amplifier (PA) and noise filtering functions in a single module dramatically limits phase error of RF signals radiated by the array of antenna elements. However, this means that high power radio frequency (RF) signals must be conveyed through the cables/connectors between the filter and antenna modules. As a result, these cables/connectors tend to be very expensive and are a significant source of PIM. To achieve a good connection between the antenna and filter modules with multiple cables/connectors sets, the structure of the antenna and filter modules have to be very rigid, which results in extra cost and weight.

Typically, the FDD PAs are always on, and are co-located with the high DC consumption Radio Application Specific Integrated Circuits (ASICs). In order to provide adequate cooling, copper coins are required to be placed inside the PCB to extract heat from the PA. This causes difficulty to route the high-speed RF links among the ASICs and the DC power plane and thermal cooling.

FDD AAS also require PIM screening tests during production, which requires an expensive and complicated test setup and long test times.

A cost effective AAS arrangement remains highly desirable.

### SUMMARY

An aspect of the present disclosure provides an Antenna Array System (AAS) comprising: a main board; and a plurality of antenna filter radio-frequency (RF) frontend modules (AFRFMs) connected to the main board. Each AFRFM includes: an antenna subarray including a plurality of antenna elements configured to transmit/receive radio frequency (RF) signals; at least one antenna radiation wall configured to limit coupling between antenna elements and provide ground plane continuity between the antenna subarray and a second antenna subarray associated with an adjacent antenna frontend module; and a filter unit coupled to the antenna subarray and configured to process the RF signals transmitted/received by the antenna elements of the antenna subarray.

In some embodiments, each antenna element is a dual polarization antenna element configured to transmit/receive radio signals on a pair of substantially orthogonal polarizations.

In some embodiments, the filter unit comprises: at least one RF filter coupled to the antenna subarray via a low-PIM connection; a front end printed circuit board (PCB) coupled to the filter unit and including at least a power amplifier configured to amplify the RF signals transmitted/received by the antenna elements of the antenna subarray; a heatsink having a wall configured to both support the front end PCB and provide a thermal path for conducting heat away from the power amplifier;

and a shield configured to surround the front end PCB and electrically connect the wall of the heatsink with a wall of the filter unit such that the shield cooperates with the wall of the heatsink and the wall of the filter unit to prevent electromagnetic interference (EMI).

In some embodiments, each AFRFM further comprises a body that includes the at least one RF filter and the shield as an integrated unit. The body may further comprise a wall configured to support the antenna subarray.

In some embodiments, the main board comprises circuitry configured to supply respective phase-corrected RF signals to each antenna frontend module.

In some embodiments, the main board comprises circuitry configured to receive respective feedback RF signals from each AFRFM.

In some embodiments, the front end printed circuit board (PCB) of each AFRFM comprises a coupled feedback path configured to supply feedback signals from either one or both of the antenna subarray and the filter unit to the main board.

In some embodiments, each AFRFM comprises a respective phase shifter configured to adjust a phase of RF signals transmitted/received from its respective antenna array.

In some embodiments, the main board comprises circuitry configured to control the respective phase shifter of each AFRFM such that at least one of: a phase error of RF signals transmitted/received by the respective antenna subarray of any one of the plurality of AFRFMs can be at least partially compensated; and an electrical tilt angle of a combined RF signal emitted by the Antenna Array System can be adjusted.

A further aspect of the present disclosure provides an antenna filter radio-frequency (RF) frontend module (AFRFM) for use in an Antenna Array System (AAS). The AFRFM comprises: an antenna subarray including a plurality of antenna elements configured to transmit/receive radio frequency (RF) signals; at least one antenna radiation wall configured to limit coupling between the antenna elements and provide ground plane continuity between the antenna subarray and a second antenna subarray associated with an adjacent antenna frontend module; and a filter unit coupled to the antenna subarray and configured to process the RF signals transmitted/received by the antenna elements of the antenna subarray.

In some embodiments, each antenna element is a dual polarization antenna element configured to transmit/receive radio signals on a pair of substantially orthogonal polarizations.

In some embodiments, the filter unit comprises: at least one RF filter coupled to the antenna subarray via a low-PIM connection; a front end printed circuit board (PCB) coupled to the filter unit and including at least a power amplifier configured to amplify the RF signals transmitted/received by the antenna elements of the antenna subarray; a heatsink having a wall configured to both support the front end PCB and provide a thermal path for conducting heat away from the power amplifier; and a shield configured to surround the front end PCB and electrically connect the wall of the heatsink with a wall of the filter unit such that the shield cooperates with the wall of the heatsink and the wall of the filter unit to prevent electromagnetic interference (EMI).

In some embodiments, the AFRFM further comprises a body that includes the at least one RF filter and the shield as an integrated unit. The body may further comprise a wall configured to support the antenna subarray.

In some embodiments, the filter unit comprises at least one waveguide filter.

In some embodiments, the front end PCB comprises a respective analog signal path for processing each of the RF signals transmitted and received by the antenna elements of the antenna subarray, each signal path comprising at least one respective power amplifier.

In some embodiments, each signal path further comprises a low noise amplifier (LNA) and a band-pass filter.

In some embodiments, the AFRFM further comprises a connector configured to electrically connect the frontend PCB to a main board of the Antenna Array System (AAS).

In some embodiments, the front end PCB comprises a coupled feedback path configured to supply feedback signals from either one or both of the antenna subarray and the filter unit to the main board via the connector.

In some embodiments, the AFRFM further comprises a phase shifter configured to adjust a phase of RF signals transmitted/received by the antenna subarray.

Further aspects of the present disclosure provides a low weight, low PIM and improved efficiency integrated antenna and filter unit for use in 4G, 5G and 6G AAS radio products by removing duplication, eliminating connectors and joint optimization Embodiments of a base station, communication system, and a method in a communication system are also disclosed.

### BRIEF DESCRIPTION OF THE DRAWINGS

The accompanying drawing figures incorporated in and forming a part of this specification illustrate several aspects of the disclosure, and together with the description serve to explain principles of the disclosure.

FIGS. 1A-1D are top, cross-sectional and exploded views of an Antenna Filter RF Frontend Module (AFRFM) in accordance with an embodiment of the present disclosure. FIG. 1B is a cross section through line A-A of FIG. 1A, and FIG. 1C is a cross section through line B-B of FIG. 1A; FIG. 1D is an exploded perspective view of the embodiment of FIGS. 1A-1C;

FIGS. 2A and 2B are schematic views illustrating respective embodiments of signal paths in the AFRFM of FIGS. 1A-1D;

FIG. 3A is a perspective view showing a radiation wall usable in conjunction with the AFRFM embodiment illustrated in FIGS. 1A-1C in accordance with an embodiment of present disclosure;

FIG. 3B is a perspective view showing a portion of an Antenna Array System (AAS) composed of AFRFMs and radiation walls, in accordance with an embodiment of present disclosure;

FIG. 4 is a cross sectional view showing a portion of an Antenna Array System (AAS) in accordance with an embodiment of present disclosure; and

FIG. 5 is a top view of an Antenna Filter RF Frontend Module (AFRFM) in accordance with another embodiment of the present disclosure;

FIG. 6 is a top view of an Antenna Array System (AAS) composed 16 AFRFMs, in accordance with an embodiment of present disclosure;

FIG. 7 is a top view showing a representative main board of an Antenna Array System (AAS) composed of multiple AFRFMs in accordance with an embodiment of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

At least some of the following abbreviations and terms may be used in this disclosure.
2D Two Dimensional
3GPP Third Generation Partnership Project
5G Fifth Generation
AAS Antenna Array System
AoA Angle of Arrival
AoD Angle of Departure
ASIC Application Specific Integrated Circuit
BF Beamforming
BLER Block Error Rate
BW Beamwidth
CPU Central Processing Unit
CSI Channel State Information
dB Decibel
DCI Downlink Control Information
DFT Discrete Fourier Transform
DSP Digital Signal Processor
eNB Enhanced or Evolved Node B
FIR Finite Impulse Response
FPGA Field Programmable Gate Array
gNB New Radio Base Station
ICC Information Carrying Capacity
IIR Infinite Impulse Response
LTE Long Term Evolution
MIMO Multiple Input Multiple Output
MME Mobility Management Entity
MMSE Minimum Mean Square Error
MTC Machine Type Communication
NR New Radio
OTT Over-the-Top
PBCH Physical Broadcast Channel
PDCCH Physical Downlink Control Channel
PDSCH Physical Downlink Shared Channel
P-GW Packet Data Network Gateway
RAM Random Access Memory
ROM Read Only Memory
RRC Radio Resource Control
RRH Remote Radio Head
SCEF Service Capability Exposure Function
SINR Signal to Interference plus Noise Ratio
TBS Transmission Block Size
UE User Equipment
ULA Uniform Linear Array
URA Uniform Rectangular Array

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network. Some examples of a core network node include, e.g., a Mobility Management Entity (MME), a Packet Data Network Gateway (P-GW), a Service Capability Exposure Function (SCEF), or the like.

Wireless Device: As used herein, a “wireless device” is any type of device that has access to (i.e., is served by) a cellular communications network by wirelessly transmitting (and/or receiving) signals to (and/or from) a radio access node. Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Cell: As used herein, a “cell” is a combination of radio resources (such as, for example, antenna port allocation, time and frequency) that a wireless device may use to exchange radio signals with a radio access node, which may be referred to as a host node or a serving node of the cell. However, it is important to note that beams may be used instead of cells, particularly with respect to 5G NR. As such, it should be appreciated that the techniques described herein are equally applicable to both cells and beams.

Note that references in this disclosure to various technical standards (such as 3GPP TS 38.211 V15.1.0 (2018-03) and 3GPP TS 38.214 V15.1.0 (2018-03), for example) should be understood to refer to the specific version(s) of such standard(s) that is(were) current at the time the present application was filed, and may also refer to applicable counterparts and successors of such versions.

The description herein focuses on a 3GPP cellular communications system and, as such, 3GPP terminology or terminology similar to 3GPP terminology is oftentimes used. However, the concepts disclosed herein are not limited to a 3GPP system.

Systems and methods are disclosed herein that provide an Antenna Filter RF Frontend Module (AFRFM) for use in an AAS, and an AAS composed of multiple such antenna RF frontend modules.

In general terms, in accordance with the present disclosure, an Antenna Array System (AAS) comprises: a main board; and a plurality of antenna filter frontend modules (AFRFMs) connected to the main board. Each AFRFM includes:
an antenna subarray including a plurality of antenna elements configured to transmit/receive radio frequency (RF) signals;
at least one antenna radiation wall configured to limit coupling between antenna elements and provide ground plane continuity between the antenna subarray and a second antenna subarray associated with an adjacent antenna frontend module; and
a filter unit coupled to the antenna subarray and configured to process the RF signals transmitted/received by the antenna elements of the antenna subarray.

In some embodiments, each antenna element is a dual polarization antenna element configured to transmit/receive radio signals on a pair of substantially orthogonal polarizations.

In some embodiments, the filter unit comprises:
at least one RF filter coupled to the antenna subarray via a low-PIM connection;
a front end printed circuit board (PCB) coupled to the filter unit and including at least a power amplifier configured to amplify the RF signals transmitted/received by the antenna elements of the antenna subarray;
a heatsink having a wall configured to both support the front end PCB and provide a thermal path for conducting heat away from the power amplifier; and
a shield configured to surround the front end PCB and electrically connect the wall of the heatsink with a wall of the filter unit such that the shield cooperates with the wall of the heatsink and the wall of the filter unit to prevent electromagnetic interference (EMI).

In some embodiments, each AFRFM further comprises a body that includes the at least one RF filter and the shield as an integrated unit. The body may further comprise a wall configured to support the antenna subarray.

In some embodiments, the main board comprises circuitry configured to supply respective phase-corrected RF signals to each antenna frontend module.

In some embodiments, the main board comprises circuitry configured to receive respective feedback RF signals from each AFRFM.

In some embodiments, the front end printed circuit board (PCB) of each AFRFM comprises a coupled feedback path configured to supply feedback signals from either one or both of the antenna subarray and the filter unit to the main board.

In some embodiments, each AFRFM comprises a respective phase shifter configured to adjust a phase of RF signals transmitted/received from its respective antenna array.

In some embodiments, the main board comprises circuitry configured to control the respective phase shifter of each AFRFM such that an electrical tilt angle of a combined RF signal emitted by the Antenna Array System can be adjusted.

In some embodiments, there is a coupler corresponding to each transmit/receive radio frequency signal that is used for antenna calibration. Starting from the output of the coupler there are two transmission line paths. The first transmission line path is part of the feed network that connects the signals to the antenna elements. The second transmission line path is the coupled signal calibration network that ultimately combines all of the coupled signals which are then connected to a calibration transmitter/receiver. Typically all of the first transmission line paths are made equal to each other. Typically all of the second transmission line paths are made equal to each other. The first transmission line paths may be split between more than one PCB within a module and there is typically more than one module in an AAS system (for example with a 2 PCB split within on module and 16 total modules there is a total of 32 PCBs). There is a tolerance on the dielectric constant (Dk) between PCBs that means that the group delay or phase for a given length of transmission line can be different and this can result in significant phase errors between branches of an AAS antenna. To compensate for this the second transmission line paths may be designed such that on each PCB with a first transmission line path there is an equal length second transmission line path on the same PCB. This may not be the most obvious or straight forward route for the second transmission line path but it has the advantage that any phase error in the first transmission line path(s) due to Dk variations will also be experience by the corresponding portions of the second transmission line path(s) and will cancel out in the antenna calibration process.

A further aspect of the present disclosure provides an antenna frontend module (AFRFM) for use in an Antenna Array System (AAS). The AFRFM comprises:
an antenna subarray including a plurality of antenna elements configured to transmit/receive radio frequency (RF) signals;
at least one antenna radiation wall configured to limit coupling between the antenna elements and provide ground plane continuity between the antenna subarray and a second antenna subarray associated with an adjacent antenna frontend module; and
a filter unit coupled to the antenna subarray and configured to process the RF signals transmitted/received by the antenna elements of the antenna subarray.

In some embodiments, each antenna element is a dual polarization antenna element configured to transmit/receive radio signals on a pair of substantially orthogonal polarizations.

In some embodiments, the filter unit comprises:
at least one RF filter coupled to the antenna subarray via a low-PIM connection;
a front end printed circuit board (PCB) coupled to the filter unit and including at least a power amplifier configured to amplify the RF signals transmitted/received by the antenna elements of the antenna subarray;
a heatsink having a wall configured to both support the front end PCB and provide a thermal path for conducting heat away from the power amplifier; and
a shield configured to surround the front end PCB and electrically connect the wall of the heatsink with a wall of the filter unit such that the shield cooperates with the wall of the heatsink and the wall of the filter unit to prevent electromagnetic interference (EMI).

In some embodiments, the AFRFM further comprises a body that includes the at least one RF filter and the shield as an integrated unit. The body may further comprise a wall configured to support the antenna subarray.

In some embodiments, the filter unit comprises at least one waveguide filter.

In some embodiments, the front end PCB comprises a respective analog signal path for processing each of the RF signals transmitted and received by the antenna elements of the antenna subarray, each signal path comprising at least one respective power amplifier.

In some embodiments, each signal path further comprises a low noise amplifier (LNA) and a band-pass filter.

In some embodiments, the AFRFM further comprises a connector configured to electrically connect the frontend PCB to a main board of the Antenna Array System (AAS).

In some embodiments, the front end PCB comprises a coupled feedback path configured to supply feedback signals from either one or both of the antenna subarray and the filter unit to the main board via the connector.

In some embodiments, the AFRFM further comprises a phase shifter configured to adjust a phase of RF signals transmitted/received by the antenna subarray.

In accordance with specific embodiments, the antenna filter RF frontend module (AFRFM) comprises a filter unit that is connected to an antenna sub-array unit via a connection that has low PIM properties. For example, a soldered connection between the filter unit and the antenna sub-array can be designed to exhibit low PIM.

The filter unit may also include a Low Noise Amplifier (LNA), calibration network couplers and Power Amplifier (PA) thermally connected to a heatsink. The AFRFM module can be a single or dual polarized module, with the dual polarized module having a dual polarized antenna subarray, two way combiner and dual filter and front end PCB (with PAS, LNAs etc). The AFRFM may also have an integrated radome as well as remote electrical tilt (RET) if desired

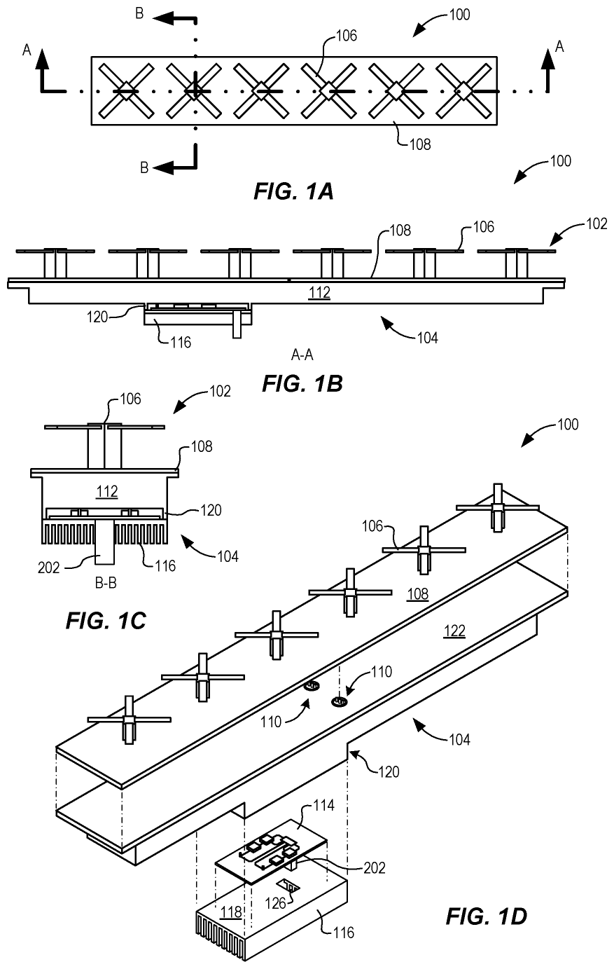

FIGS. 1A-1D shows principal components of a representative AFRFM 100 in accordance with embodiments of the present disclosure. The illustrated AFRFM 100 generally comprises an antenna subarray 102 and a filter unit 104. The antenna subarray 102 includes a plurality of antenna elements 106 (six antenna elements in the illustrated embodiment) mounted on an antenna array printed circuit board (PCB) 108. In the illustrated embodiment, the antenna elements 106 are configured as dual polarization dipole antennas. Other antenna configurations (such as single-polarization, or circular patch antennas) may be used.

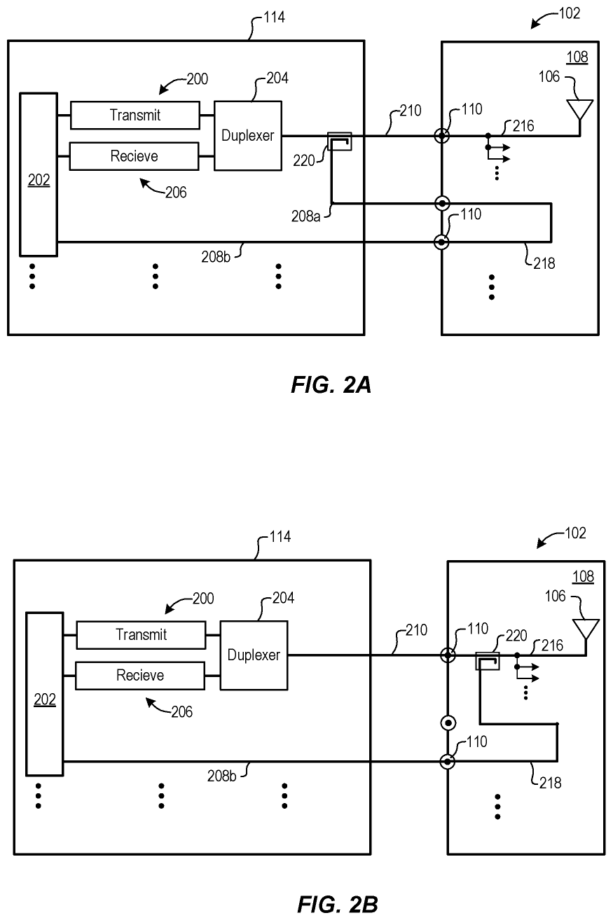

The antenna array PCB 108 provides a physical support for the antenna elements 106 and a set of RF feedlines (e.g. microstrip or stripline connections, FIG. 2) for connecting each antenna element 106 to a low passive intermodulation (PIM) connection 110 to the filter unit 104. Preferably, the antenna array PCB 108 is configured as a multi-layer pcb of a type known in the art. In this case, one layer (e.g. a top layer) of the multi-layer antenna array PCB 108 may also provide a ground plane for the antenna elements 106.

The low PIM connection(s) 110 may, for example, be constructed in a manner known from International Patent Publication No. WO 2020/212819 dated Oct. 22, 2020, and/or International Patent Publication No. WO 2021/148987 dated Jul. 29, 2021, the entire content of which is incorporated herein by reference. The low PIM connection 110 may also be designed to accept a removable test connector (not shown) for tuning the filter unit 104 prior to soldering to the antenna sub-array PCB 108.

The filter unit 104 generally comprises at least one RF cavity filter 112, a front end printed circuit board (PCB) 114, and a heatsink 116.

The at least one RF cavity filter 112 may be provided as any suitable combination of air-filled and/or ceramic waveguides and resonators, all of which are generally known in the art. In the case of dual polarization antenna elements 106, respective waveguide and/or resonator filters may be provided for each polarization, and are connected to the antenna subarray PCB 108 via respective low-PIM connections 110.

FIGS. 2A and 2B schematically illustrate signal paths in the front end printed circuit board (PCB) 114 and the subarray PCB 108. In the embodiment of FIG. 2A, for each polarization, the front end PCB 114 includes an analog RF signal transmit path 200 extending between a main board connector 202 and a duplexer 204; an analog RF signal receive path 206 extending between the duplexer 204 and the main board connector 202; and first and second feedback signal paths 208a-b.

The analog RF signal transmit and receive paths 200 and 206 include at least a power amplifier (not shown) configured to amplify the RF signals transmitted/received by the antenna elements 106 of the antenna subarray 102. As may be seen in FIG. 2A, analog RF signals are coupled through a transmission line 210 between the duplexer 204 and a distribution network 216 that connects the low PIM connection 110 to each of the antenna elements 106.

Analog feedback signals are sampled by a coupler 220 on the transmission line 210 near the duplexer 204 and are coupled through a feedback network to a feedback port (not shown) associated with the main board connector 202. As may be seen in FIG. 2A, the feedback network comprises the first feedback signal path 208a which extends from the coupler 220 to a path loop 218 on the subarray PCB 108, which is further coupled to the second feedback path 208b. In some embodiments transmission lines forming the distribution network 216 on the subarray PCB 108 have equal length, which is also made equal to the length of the path loop 218. This arrangement is beneficial in that it limits calibration errors due to dielectric constant variations between different PCBs.

The Embodiment of FIG. 2B is similar to that of FIG. 2A, except that the coupler 220 is relocated to the subarray PCB 108, which eliminates the need for the first feedback signal path 208a on the front end PCB 114. As in the embodiment of FIG. 2A, in some embodiments transmission lines forming the distribution network 216 on the subarray PCB 108 have equal length, which is also made equal to the length of the path loop 218, which limits calibration errors due to dielectric constant variations between different PCBs.

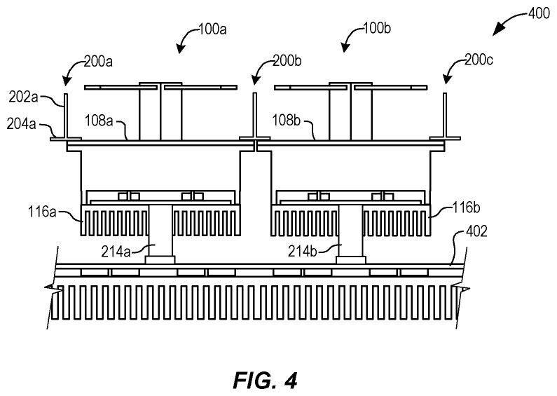

In the embodiment illustrated in FIG. 1, the main board connector 202 is configured to extend through an opening 126 in the heatsink 116. In some embodiments, the main board connector 202 may be configured in a manner known in the art to provide low-loss and/or low PIM signal paths to and from a main board (See FIG. 4) of an Antenna Array System (AAS) that includes multiple instances of the AFRFM 100. In some embodiments, the filter connectors 204 may be configured as low passive intermodulation connectors closely similar to the low-PIM connectors 110 between the RF filter(s) 112 and the subarray PCB 108.

In the illustrated embodiment, the heatsink 116 further includes a wall 118 configured to both support the front end PCB 114 and provide a thermal path for conducting heat away from the power amplifier and other power dissipating components of the front end PCB 114.

Electromagnetic coupling (EMC) and/or electromagnetic interference (EMI) into or from the front end PCB 114 can be blocked by providing a shield 120 configured to surround the front end PCB 114. In the illustrated embodiment, the shield 120 is provided as a metallic wall extending from the at least one filter 112 and designed to electrically (or at least capacitively) connect to the wall 118 of the heatsink 116 so that the front end PCB 114 is enclosed within a cavity defined by the heatsink 116, the at least one filter 112 and the shield 120.

The filter unit 104 may include a metallic (e.g. aluminum) body configured to incorporate one or more filters 112, the shield 120 and any necessary connection points (not shown) for mechanically securing the antenna subarray 102, filter unit 104 and heatsink 116 together. For example, the body may include a wall 122 configured to receive and support the antenna subarray pcb 108. This arrangement is advantageous in that it enables the assembly of the components of the AFRFM 100 in a compact, robust and lightweight module.

The filter unit 104 may also be configured to be calibrated after connection with the sub-array 102 to get the best return loss, and thereby helping to further minimize overall losses. A calibration network comprising signal paths for this purpose are known, for example from International Patent Publication No. WO 2020/212819 dated Oct. 22, 2020. In some embodiments, calibration and testing signal paths (e.g. from the low PIM connections 110 may be provided in the frontend PCB 114. These signal paths may also extend through the main board connector 124 to simplify connection to test and/or calibration equipment (not shown) via the main board. Alternatively, suitable signal paths and connectors (not shown) may be provided in the sub-array PCB 108 for connection to test and/or calibration equipment.

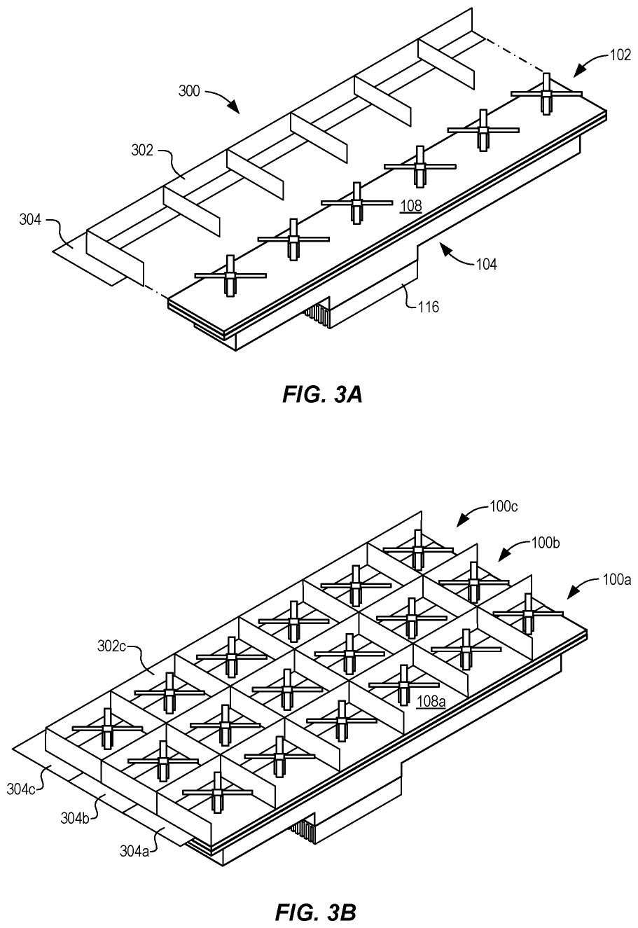

Referring to FIG. 3A, in some embodiments the sub-array 102 is provided with at least one radiation wall 300, which includes a vertical portion 302 and a flange portion 304. The vertical portion 302 is configured to minimize cross-talk between adjacent antenna elements 106, in a manner known, for example from International Patent Publication No. WO 2020/212819 dated Oct. 22, 2020. On the other hand, the flange portion 304 is provided to bridge a gap between adjacent AFRFM modules 100 in an AAS system. For example, FIG. 3B illustrates a set of three AFRFM modules 100a-100c positioned adjacent to one another to form a portion of an AAS system. In this case, the flange portions 304a-304c operate to bridge any gaps between adjacent modules 100, and particularly between the respective sub-array PCBs 108. As may be appreciated, bridging the gaps in this manner ensures continuity of the ground plane across the assembled AAS, which improves the RF performance of the AAS. As described above, in some embodiments, an upper metal layer of the sub-array PCB 108 can be used as the ground plane for the antenna subarray 102. The upper layer (i.e. the ground plane) will typically be covered by a dielectric coating in a manner known in the art. In this case, the flange portion 304 of each radiation wall 300 may be secured to the sub-array PCB 108 by adhesive bonding, or by electrically non-conductive mechanical fasteners such as plastic rivets or screws. This arrangement ensures a capacitive coupling between the flange portion 304 and the ground plane of the sub-array PCB 108, which contributes to minimizing PIM.

FIG. 4 illustrates a partial cross section through an AAS 400, in which two adjacent AFRFMs 100a-100b are shown connected to a main board 402. As may be seen in FIG. 4, the respective flange portions 204 of the radiation walls 200a-200c are located to bridge any gaps between the adjacent antenna subarray PCBs 108a, 108b, and so ensure electrical continuity of the assembled AAS ground plane.

The embodiment of FIGS. 1-2 may be described as a N=1×M=1×P=6 dual polarized AFRFM, where: N is the number of rows, M is the number of columns, and P is the number of antenna elements 106 per column. An embodiment having single-polarized antenna elements 106 may be described as a 1×1×6 single polarized AFRFM.

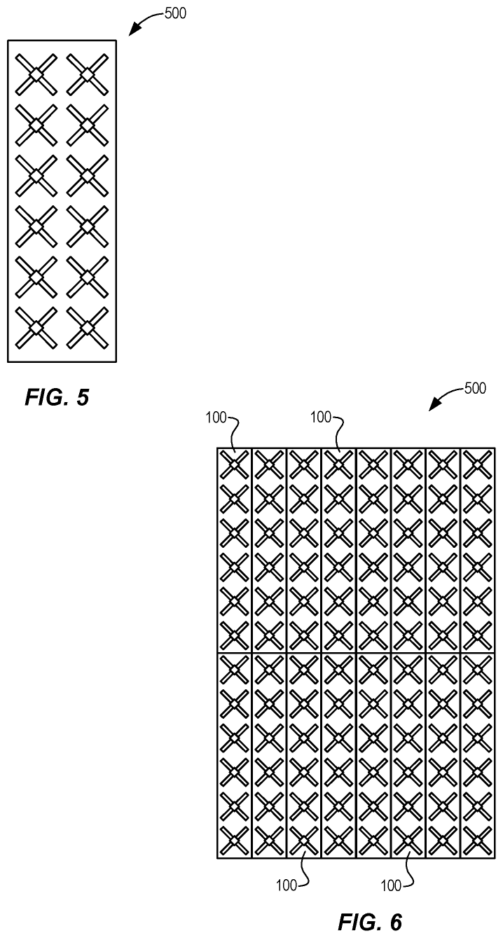

FIG. 5 illustrates an alternative embodiment having N=1 rows, M=2 columns and P=6 antenna elements 106 per column. Thus the embodiment of FIG. 5 may be described as a 1×2×6 dual (or single) polarized AFRFM 500. Preferably, a single antenna array PCB 108 supports all of the antenna elements 106 and provides a continuous ground plane across the entire module. In some embodiments, the AFRFM 500 may include an integrated filter unit 104 that includes respective RF filter(s) 112 and a front end printed circuit board (PCB) 114 for each column of antenna elements 106, and a common heat sink 116. Accordingly, the 1×2×6 dual polarized AFRM 500 of FIG. 5 may include four RF filter 112 and two front end PCBs 114.

In other embodiments, antennal elements 106 may be grouped together in other combinations (such as rectangular 2×2 subarrays of antenna elements) with each combination being connected to a respective one or more RF filter(s) 112 and a front end PCB 114.

As may be appreciated, a larger array system can be assembled with separate N×M×P AFRFM modules to form a large AFRFM array system as shown in FIG. 6. In the illustrated example, sixteen 1×1×6 dual polarized AFRFM modules 100 are arranged in a 2-row by 8-column AFRFM array system 600.

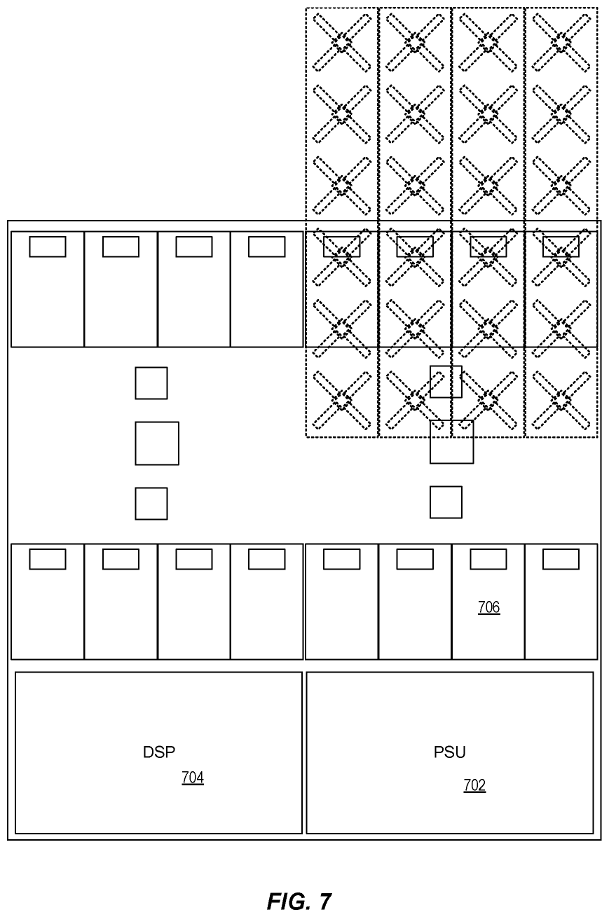

FIG. 7 illustrates an example main board 700 configured to support the 2-row by 8-column AFRFM array system 600 in an AAS assembly. As may be seen in FIG. 6, the main board 700 generally comprises a power supply unit (PSU) 702, a digital signal processing (DSP) block 704, and a respective driver block 706 for each AFRFM 100 in the 2×8 array system 600. Each driver block 706 may be coupled to its respective ARFRM 100 via the connector 124 (FIG. 1C-1D).

In some embodiments, the DSP 704 is configured to provide digital signal conditioning and linearization functions known in the art, while each driver block 706 provides analog-to-digital convertor (ADC) and digital-to-analog convertor (DAC) functions for its respective AFRFM 100. This arrangement is beneficial in that it places all digital signal processing functions on the main board 700 and analog signal processing functions (primarily PA and LNA) in each AFRFM 100. Locating digital signal processing functions on the main board 700 simplifies compensation of phase errors, for example, which are typically caused by differential signal path lengths between the DSP 704 and each AFRFM 100. At the same time, locating analog PA and LNA functions in the AFRFM 100 reduces the performance requirements of each PA and LNA device, which significantly reduces cost.

If desired, the AAS assembly may also include an integrated radome and/or electronic tilt mechanisms in a manner known in the art.

Various embodiments of the present disclosure may provide at least some of the following advantages for AAS products:
With the integration of the filter and antenna many aspects of the mechanical structure serve dual purposes for mechanical support, electromagnetic shielding, and antenna ground plane resulting in lower cost and weight for the assembled module.
The coupling of the filter and antenna via the low-PIM connection 110 improves the PIM performance of the overall AAS as conventional (e.g. bullet-type) connectors are a significant source of PIM.
Return loss performance may be improved by jointly optimizing and tuning the antenna subarray and filter, as well as removal of the loss associated with detachable connectors. This may improve the efficiency of the overall AAS.
Reduced time to market as testing and development of the AFRFM contains all frequency specific aspects of the completed module;
Reduced field return rate due to low PIM design and testing of a single unit containing all PIM critical interconnects;
AFRFMs 100 can be replicated with close mechanical and electrical tolerances, which simplifies assembly and calibration of an AAS, at least in part by reducing phase errors between AFRFMs within an assembled AAS;
The PA and LNA are located at the minimum loss feed point of the antenna subarray feed network, which improves efficiency and reduces the performance requirements of these components and consequently also reduces costs.
By having equal transmission line lengths in the portion of the network following the calibration network couplers and calibration network transmission lines on each AFRFM PCB a major source of calibration errors due to dielectric constant variations between different PCBs is largely eliminated.

While processes in the figures may show a particular order of operations performed by certain embodiments of the present disclosure, it should be understood that such order is representative, and that alternative embodiments may perform the operations in a different order, combine certain operations, overlap certain operations, etc.

Those skilled in the art will recognize improvements and modifications to the embodiments of the present disclosure. All such improvements and modifications are considered within the scope of the concepts disclosed herein.

1. An antenna array system (AAS) comprising:
a main board; and
a plurality of antenna filter radio frequency (RF) frontend modules (AFRFMs) connected to the main board, each AFRFM including:
an antenna subarray including a plurality of antenna elements configured to transmit/receive RF signals;
at least one antenna radiation wall configured to limit coupling between antenna elements and provide ground plane continuity between the antenna subarray and a second antenna subarray associated with an adjacent antenna frontend module; and
a filter unit coupled to the antenna subarray and configured to process the RF signals transmitted/received by the antenna elements of the antenna subarray.

2. The AAS of claim 1, wherein each antenna element is a dual polarization antenna element configured to transmit/receive radio signals on a pair of substantially orthogonal polarizations.

3. The AAS of claim 1, wherein the filter unit comprises:
at least one RF filter coupled to the antenna subarray via a low-PIM connection;
a front end printed circuit board (PCB) coupled to the filter unit and including at least a power amplifier configured to amplify the RF signals transmitted/received by the antenna elements of the antenna subarray;
a heatsink having a wall configured to both support the front end PCB and provide a thermal path for conducting heat away from the power amplifier; and
a shield configured to surround the front end PCB and electrically connect the wall of the heatsink with a wall of the filter unit such that the shield cooperates with the wall of the heatsink and the wall of the filter unit to prevent electromagnetic interference (EMI).

4. The AAS of claim 3, wherein each AFRFM further comprises a body that includes the at least one RF filter and the shield as an integrated unit.

5. The AAS of claim 4, wherein the body further comprises a wall configured to support the antenna subarray.

6. The AAS of claim 1, wherein the main board comprises circuitry configured to supply respective phase-corrected RF signals to each antenna frontend module.

7. The AAS of claim 1, wherein the main board comprises circuitry configured to receive respective feedback RF signals from each AFRFM.

8. The AAS of claim 7, wherein the front end printed circuit board (PCB) of each AFRFM comprises a coupled feedback path configured to supply feedback signals from either one or both of the antenna subarray and the filter unit to the main board.

9. The AAS of claim 1, wherein each AFRFM comprises a respective phase shifter configured to adjust a phase of RF signals transmitted/received from its respective antenna sub-array.

10. The The AAS of claim 9, wherein the main board comprises circuitry configured to control the respective phase shifter of each AFRFM such that an electrical tilt angle of a combined RF signal emitted by the Antenna Array System can be adjusted.

11. An antenna filter radio frequency (RF) frontend module (AFRFM) for use in an Antenna Array System (AAS), the AFRFM comprising:
an antenna subarray including a plurality of antenna elements configured to transmit/receive RF signals;
at least one antenna radiation wall configured to limit coupling between the antenna elements and provide ground plane continuity between the antenna subarray and a second antenna subarray associated with an adjacent antenna frontend module; and
a filter unit coupled to the antenna subarray and configured to process the RF signals transmitted/received by the antenna elements of the antenna subarray.

12. The AFRFM of claim 11, wherein each antenna element is a dual polarization antenna element configured to transmit/receive radio signals on a pair of substantially orthogonal polarizations.

13. The AFRFM of claim 11, wherein the filter unit comprises:
at least one RF filter coupled to the antenna subarray via a low-PIM connection;
a front end printed circuit board (PCB) coupled to the filter unit and including at least a power amplifier configured to amplify the RF signals transmitted/received by the antenna elements of the antenna subarray;
a heatsink having a wall configured to both support the front end PCB and provide a thermal path for conducting heat away from the power amplifier; and
a shield configured to surround the front end PCB and electrically connect the wall of the heatsink with a wall of the filter unit such that the shield cooperates with the wall of the heatsink and the wall of the filter unit to prevent electromagnetic interference (EMI).

14. The AFREM of claim 11, further comprising a body that includes the at least one RF filter and the shield as an integrated unit.

15. The AFRFM of claim 14, wherein the body further comprises a wall configured to support the antenna subarray.

16. The AFRFM of claim 11, wherein the filter unit comprises at least one waveguide filter.

17. The AFRFM of claim 13, wherein the front end PCB comprises a respective analog signal path for processing each of the RF signals transmitted and received by the antenna elements of the antenna subarray, each analog signal path comprising at least one respective power amplifier.

18. (canceled)

19. The AFRFM of claim 17, further comprising a connector configured to electrically connect the frontend PCB to a main board of the Antenna Array System (AAS).

20. The AFRFM of claim 19, wherein the front end PCB comprises a coupled feedback path configured to supply feedback signals from either one or both of the antenna subarray and the filter unit to the main board via the connector.

21. (canceled)

22. The antenna filter RF frontend module as claimed in claim-The AFRFM of claim 20, wherein:
the coupled feedback path on the front end PCB is connected to a feedback loop on the antenna subarray;
the analog signal paths are connected to a distribution network on the antenna subarray, ; and
each transmission line of the distribution network has an equal length, which is equal to a length of the feedback loop on the antenna subarray.
